(19) United States
(12) Patent Application Publication
(10) Pub. No.: US 2026/0104725 A1
(43) Pub. Date: Apr. 16, 2026

(54) POINT OF LOAD VOLTAGE REGULATION

(71) Applicant: TEXAS INSTRUMENTS INCORPORATED, Dallas, TX (US)

(72) Inventors: Reza Sharifi, Sunnyvale, CA (US); Yat Hei Lam, San Jose, CA (US); Pengyu Gu, San Franciso, CA (US)

(21) Appl. No.: 19/353,720

(22) Filed: Oct. 9, 2025

Related U.S. Application Data
(60) Provisional application No. 63/706,089, filed on Oct. 11, 2024.

(51) Int. Cl. G05F 1/575; G05F 1/46; G05F 1/56

(52) U.S. Cl. CPC G05F 1/575; G05F 1/468; G05F 1/561

(57) ABSTRACT

Described embodiments include an electronic circuit having a reference voltage terminal, a regulator output terminal, and a feedback terminal. A first amplifier has a first input coupled to the reference voltage terminal and a second input coupled to the feedback terminal. A first transistor has first and second terminals and a control terminal. The control terminal of the first transistor is coupled to the output of the first amplifier. The first terminal of the first transistor is coupled to a supply voltage terminal, and the second terminal of the first transistor is coupled to the regulator output terminal. A first resistor is coupled between the second input of the first amplifier and the feedback terminal. An auxiliary circuit has an input and an output. The output of the auxiliary circuit is coupled to the second input of the first amplifier.

### CROSS-REFERENCE TO RELATED APPLICATION

This application claims priority to U.S. Patent Application No. 63/706,089, filed Oct. 11, 2024, which is incorporated herein by reference in its entirety.

### TECHNICAL FIELD

The present disclosure relates generally to an electronic system and method, and, in particular embodiments, to a point of load voltage regulator.

### BACKGROUND

LDOs that power remote loads can have degraded DC voltage regulation accuracy due to electrical resistance and parasitic impedances from printed circuit board (PCB) traces and cables. The inaccuracy of the regulated voltage may increase as the load current increases. To ensure that the voltage supplied to the load by the LDO is within specification, the LDO needs to compensate for any voltage drops between its output and the load.

In many systems, the LDO feedback terminal connection is moved as close as possible to the load to account for voltage drops across the PCB traces and cabling.

### SUMMARY

In accordance to an embodiment, an electronic circuit includes: a reference voltage terminal; a regulator output terminal; a feedback terminal; a first amplifier having first and second inputs and an output, the first input of the first amplifier coupled to the reference voltage terminal, the second input of the first amplifier coupled to the feedback terminal; a first transistor having first and second terminals and a control terminal, the control terminal of the first transistor coupled to the output of the first amplifier, the first terminal of the first transistor coupled to a supply voltage terminal, and the second terminal of the first transistor coupled to the regulator output terminal; a first resistor coupled between the second input of the first amplifier and the feedback terminal; and an auxiliary circuit having an input and an output, the output of the auxiliary circuit coupled to the second input of the first amplifier.

In accordance to an embodiment, a method includes: receiving a reference voltage at a reference input of a linear voltage regulator; providing an output, by the linear voltage regulator, at an output terminal of the linear voltage regulator, based on the reference voltage; and sinking an offset current from a resistor that is coupled between the output of the linear voltage regulator and a feedback input of the linear voltage regulator to cause a voltage at a load that is coupled to the output of the linear voltage regulator to be regulated to a target voltage.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 shows a schematic diagram of a voltage regulator with a higher bandwidth inner control loop and a lower bandwidth outer control loop, according to an embodiment of the present disclosure;

FIG. 2 shows a schematic diagram of a voltage regulator with a higher bandwidth inner control loop and a lower bandwidth outer control loop that uses a single DAC to provide the voltages VREG and VDAC, according to an embodiment of the present disclosure;

FIG. 3 shows a plot of voltages and currents versus time of a voltage regulator with a higher bandwidth inner control loop and a lower bandwidth outer control loop, according to an embodiment of the present disclosure; and

FIG. 4 shows a flow diagram of an embodiment method for point of load voltage regulation, according to an embodiment of the present disclosure.

Corresponding numerals and symbols in different figures generally refer to corresponding parts unless otherwise indicated. The figures are drawn to clearly illustrate relevant aspects of preferred embodiments and are not necessarily drawn to scale.

### DETAILED DESCRIPTION

The making and using of the embodiments disclosed are discussed in detail below. It should be appreciated, however, that the present disclosure provides many applicable inventive concepts that can be embodied in a wide variety of specific contexts. The specific embodiments discussed are merely illustrative of specific ways to make and use the disclosure, and do not limit the scope of the disclosure.

The description below illustrates various specific details to provide an in-depth understanding of several example embodiments according to the description. The embodiments may be obtained without one or more of the specific details, or with other methods, components, materials and the like. In some cases, known structures, materials or operations are not shown or described in detail so as not to obscure the different aspects of the embodiments. References to “an embodiment” or “an example” in this description indicate that a particular configuration, structure or feature described in relation to the embodiment is included in at least one embodiment. Consequently, phrases such as “in one embodiment” or “in one example” that may appear at different points of the present description do not necessarily refer exactly to the same embodiment. Furthermore, specific formations, structures or features may be combined in any appropriate manner in one or more embodiments.

Several aspects of the disclosure are described below with reference to example applications for illustration. It should be understood that numerous specific details, relationships, and methods are set forth to provide an understanding of the disclosure. The present disclosure is not limited by the illustrated ordering of acts or events, as some acts may occur in different orders and/or concurrently with other acts or events.

Some embodiments relate to circuits for voltage regulation. For example, some embodiments relate to low dropout voltage regulators (LDOs) that provide a regulated voltage for powering remote loads.

Some embodiments relate to low dropout voltage regulators (LDOs) that provide a regulated voltage for powering remote loads such as a cellphone or display. LDOs that power remote loads can have poor DC voltage regulation accuracy due to electrical resistance and parasitic impedances from printed circuit board (PCB) traces and cables. The inaccuracy of the regulated voltage can increase with higher load currents. To ensure that the voltage supplied to the load by the LDO is within specification, the LDO needs to compensate for any voltage drops between the output of the LDO and the load.

In many systems, the LDO feedback terminal connection is moved as close as possible to the load to account for voltage drops across the PCB traces and cabling. While this approach may address the LDO accuracy at the load, moving the feedback terminal connection to the load can result in PCB and cable parasitics becoming part of the LDO voltage control loop, which may cause the LDO to become unstable under some conditions. This can result in lower bandwidth and degraded LDO performance characteristics, including power supply rejection ratio (PSRR) and line transients.

A challenge to overcome is that the LDO is generally not located where the load is located and the voltage provided by the LDO is generally expected to be regulated at the load, not at the output of the LDO. Some embodiments include an additional lower bandwidth outer control loop around the primary LDO voltage control loop to regulate the voltage at the load. The secondary/outer loop has lower bandwidth than the primary inner voltage control loop to minimize any impact on the stability and performance of the primary inner voltage control loop.

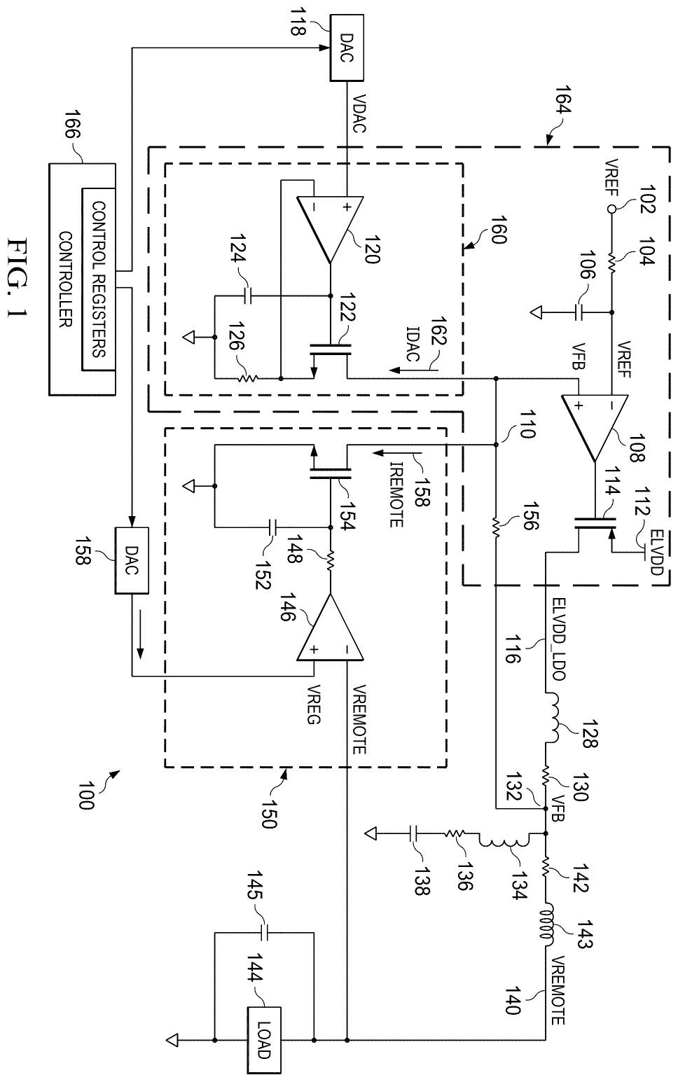

FIG. 1 shows a schematic diagram of LDO 100 with a higher bandwidth inner control loop 164 and a lower bandwidth outer control loop 150, according to an embodiment of the present disclosure. Inner control loop 164 includes resistor 104, capacitor 106, amplifier 108, transistor 114 and voltage-to-current (V2I) circuit 160. V2I circuit 160 includes amplifier 120, capacitor 124, resistor 126 and transistor 122.

As shown, resistor 104 and capacitor 106 form a low pass filter. A reference voltage VREF 102 is provided to the input of the low pass filter made up of resistor 104 and capacitor 106 which may remove AC noise without significantly attenuating the DC voltage of reference voltage VREF 102. The filtered VREF voltage is provided to the inverting input of amplifier 108. The non-inverting input of amplifier 108 is coupled to a feedback voltage terminal VFB 132 through resistor 156. The output of amplifier 108 is coupled to the gate of transistor 114. The source of transistor 114 is coupled to a supply voltage terminal ELVDD 112 and the drain of transistor 114 is coupled to the LDO output terminal ELVDD_LDO 116.

In some embodiments, feedback voltage terminal VFB 132 can be shorted to ELVDD_LDO 116 through traces in a printed circuit board (PCB), but there may be some parasitic inductance L_{PCB} 128 and parasitic resistance R_{PCB} 130 in the PCB traces that may cause a voltage drop between the two terminals. The feedback voltage terminal VFB 132 is coupled to the non-inverting input of amplifier 108 through resistor 156.

Capacitor 138 is coupled between the feedback voltage terminal VFB 132 and a ground terminal. Capacitor 138 may have an equivalent series resistance (ESR) 136 and an equivalent series inductance (ESL) 134. A remotely located load 144 having a load capacitance C_{LOAD} 145 is coupled to the feedback voltage terminal VFB 132 by a cable having a resistance R_{CABLE} 142 and an inductance L_{CABLE} 143. The voltage delivered to the load is VREMOTE 140. Ideally, the voltage at the load VREMOTE 140 is equal to the voltage at the feedback voltage terminal VFB 132, but there may be a voltage drop between the voltage being delivered to the load VREMOTE 140 and the feedback voltage terminal VFB 132 due to the current being delivered to the load flowing through the resistance of the cable R_{CABLE} 142. So, the voltage being delivered to the load VREMOTE 140 may be lower than the voltage at the feedback voltage terminal VFB 132.

The output of the LDO ELVDD_LDO 116 is coupled to the drain of transistor 114 and, in many cases, is connected to a terminal on a printed circuit board. There can be a parasitic inductance L_{PCB} 128 and a parasitic resistance R_{PCB} 130 in the printed circuit board that when combined with the parasitic inductance and resistance of capacitor 138, can produce poles and zeroes that may disrupt the stability of the inner control loop 164 if their effects are not mitigated.

Two common approaches for LDO regulation of a voltage being provided to a remote load include (1) connecting the LDO feedback voltage terminal to the output of the LDO, and (2) connecting the LDO feedback voltage terminal to the load, which is the desired regulation point. Connecting the LDO feedback voltage terminal to the output of the LDO may be preferable for the stability of the voltage control loop but may not regulate the actual desired voltage. This can result in a load-dependent voltage drop that manifests as an error in the voltage being provided to the load. The larger the load, the higher that voltage error is. A possible problem with connecting the LDO feedback voltage terminal to the load is that parasitics from the printed circuit board, cable, and the output capacitor can interfere with the feedback loop and degrade the stability and performance of the LDO.

Some embodiments add a lower bandwidth remote sensing loop 150 as an outer control loop around the higher bandwidth inner control loop 164. Outer control loop 150 includes amplifier 146, resistor 148, capacitor 152, and transistor 154. The inverting input of amplifier 146 is coupled to the load 144 and receives the voltage VREMOTE 140. The non-inverting input of amplifier 146 is coupled to the output of digital-to-analog converter (DAC) 158 and receives a target regulation voltage VREG.

The output of amplifier 146 is coupled to a first terminal of resistor 148. A second terminal of resistor 148 is coupled to the gate of transistor 154. Capacitor 152 has a first terminal coupled to the gate of transistor 154 and a second terminal coupled to the source of transistor 154. The drain of transistor 154 is coupled to the inverting input of amplifier 108 and to the drain of transistor 122 in V2I circuit 160. Amplifier 120 has a non-inverting input coupled to the output of DAC 118 and receives a reference voltage VDAC. The output of amplifier 120 is coupled to the gate of transistor 122. Capacitor 124 has a first terminal coupled to the output of amplifier 120 and a second terminal coupled to the ground terminal. Resistor 126 has a first terminal coupled to the source of transistor 122 and a second terminal coupled to the ground terminal.

The inner control loop 164 includes an amplifier 108 that compares a reference voltage VREF to a feedback voltage from the LDO output ELVDD_LDO 116, usually through traces of a PCB which may have a parasitic inductance L_{PCB} and parasitic resistance R_{PCB}. The desired voltage regulation point is the voltage VREMOTE 140 at the load 144.

In some embodiments, LDO 100 includes three voltage terminals: the LDO output terminal ELVDD_LDO 116 at the drain of transistor 114, a feedback voltage terminal VFB 132 which is between the transistor and the PCB inductance and resistance, and a remote voltage sense terminal VREMOTE 140 at the location to be regulated, the load 144. In some cases, the feedback voltage terminal VFB 132 can be shorted to the LDO output ELVDD_LDO 116 (e.g., via a PCB, or internally in the integrated circuit, such as by shorting VFB with ELVDD_LDO, or, in some embodiments, implementing inductor 128 as part of the integrated circuit). In some cases, capacitor 138 is connected to the LDO output terminal ELVDD_LDO 116, and the network of parasitic inductance L_{PCB} 128 and parasitic resistance R_{PCB} 130 can be minimized, so the feedback voltage terminal VFB 132 is not needed.

If the feedback voltage terminal VFB 132 is moved to the load 144 so that VFB 132 is at the same voltage as VREMOTE 140, then the LDO may regulate this voltage to the desired target voltage from a DC perspective. However, if the voltage at the feedback voltage terminal VFB 132 is then used for compensation in the V2I circuit 160, the poles and zeros created by R_{CABLE} 142, L_{CABLE} 143, ESL 134, ESR 136, R_{PCB} 130, and L_{PCB}128 may impact the stability of the inner control loop and compromise the performance of the inner control loop.

In LDO 100, the feedback voltage terminal VFB 132 is connected to the top terminal of capacitor 138. Resistor 156 has a resistance RFB and is coupled between the feedback voltage terminal VFB 132 and the inverting input of amplifier 108. DAC 188 provides a voltage VDAC to the non-inverting terminal of amplifier 120. The output of amplifier 120 is coupled to the gate of transistor 122 and controls transistor 122, producing a programmable current IDAC 162 that flows through transistor 122.

The voltage at the feedback voltage terminal VFB 132 can be controlled by controlling the current IDAC 162 because this voltage may be equal to VREF after the voltage drop across resistor 156. As the current through resistor 156 increases, the voltage drop across resistor 156 increases, which increases the voltage that the feedback voltage terminal VFB 132 is regulated to because amplifier 108 will drive the voltage applied to its inverting terminal to be equal to VREF.

The inner control loop 164 provides a regulated voltage compensated to account for parasitics such as PCB parasitics and the parasitics from capacitor 138. The ESL 134 and ESR 136 of capacitor 138 are known, so inner control loop 164 is compensated based on these parasitics and the overall gain of the system. This compensation allows the inner control loop 164 to operate with adequate phase margin to maintain stability.

The outer control loop 150 compares the voltage at the load VREMOTE 140 to the desired target voltage. The outer control loop 150 may take over control of the DC voltage regulation and regulate the voltage VREMOTE 140 to VREG, which is provided by DAC 158 and is the desired voltage at VREMOTE 140. Amplifier 146 compares the voltage at the load VREMOTE 140 to the target voltage VREG and pulls additional current from resistor 156 to increase the voltage at the feedback voltage terminal VFB 132 to regulate VREMOTE 140 to the voltage VREG. This may create an offset voltage that is provided to the inner control loop 164 to compensate for the voltage drop across the cable.

In some embodiments, the outer control loop 150 provides unidirectional compensation to the inner control loop 164. The compensation is unidirectional because the voltage at the load VREMOTE 140 is always equal to or lower than the voltage at the feedback voltage terminal VFB 132, so the compensation only increases the voltage at the feedback voltage terminal VFB 132, never decreases it, to regulate the voltage at the load 144 to the target voltage VREG.

In some embodiments, the outer control loop 150 may provide bidirectional compensation to the inner control loop 164 (e.g., by including a pull up transistor (not shown) coupled to node 110, so that outer control loop also has the ability to pull up node 110 in response to VREMOTE).

The outer control loop 150 allows the feedback from the inner control loop to come from capacitor 138 without suffering ill effects from the other parasitics after capacitor 138 without compromising the bandwidth and performance of the LDO due to the resistance of the cable and the remote parasitics. The outer control loop 150 helps to regulate the voltage at the load VREMOTE 140 to the desired target voltage.

The outer control loop 150 determines the error between VREG and VREMOTE 140 and injects an offset current proportional to that error. In some embodiments, the outer control loop 150 has a lower bandwidth than the inner control loop 164 which may be beneficial for stability purposes. Thus, in some embodiments, the voltage at VREMOTE 140 does not react instantaneously to changes, but instead reacts to the average. This may help to maintain stability in the outer control loop 150.

In some embodiments, controller 166 includes control registers that provide a reference voltage command to the input of DAC 118. This reference voltage command is converted to an analog voltage VDAC which is compared to a feedback voltage equal to the voltage across resistor 126. The output of amplifier 120 is coupled to the gate of transistor 122 and drives transistor 122 to regulate the voltage across resistor 126 to the voltage VDAC. This regulation produces an offset current IDAC which is equal to VDAC divided by the resistance of resistor 126. This current IDAC 162 flows through resistor 156. There is no current going to the non-inverting input of amplifier 108, but the voltage is level shifted by the magnitude of IDAC multiplied by the resistance of resistor 156. The voltage at the feedback voltage terminal VFB 132 is proportional to VDAC, so if VDAC changes, the voltage at the feedback voltage terminal VFB 132 changes proportionally.

In some embodiments, controller 166 includes control registers that provide a programmable target output voltage command to the input of DAC 158. This target output voltage command is converted to an analog voltage VREG that is provided to the non-inverting input of amplifier 146. The voltage VREG and the voltage VDAC are always proportional but may have a different scale factor. In some cases, a single DAC may be used for providing both voltages VREG and VDAC.

In some embodiments, controller 166 may be implemented as a generic or custom processor or controller coupled to a memory and configured to execute instructions in such memory. In some embodiments, controller 166 may be implemented using a field programmable gate array (FPGA). In some embodiments, controller 166 includes combinational logic, sequential logic, programmable logic (e.g., in combination with program memory), or the like, or a combination thereof. In some embodiments, controller 166 includes a state machine. In some embodiments, controller 166 includes a hardware accelerator. In some embodiments, controller 166 is implemented using (e.g., only) synthesized logic. Other implementations may also be possible.

In some embodiments, inner control loop 164, outer control loop 150, DACs 118 and 158, and controller 166 are implemented in a single integrated circuit (IC), such as in a single monolithic die. In some embodiments, such IC may be implemented in a PCB, with inductor 128, capacitor 138, load 144 also implemented (e.g., discretely) in the PCB. In some embodiments, inductor 128 may also be included in the IC (e.g., separate from the die and coupled to the die). In some embodiments, one or more (or all) of the elements shown in FIG. 1 may be implemented with discrete components (e.g., in a PCB). Other implementations may also be possible.

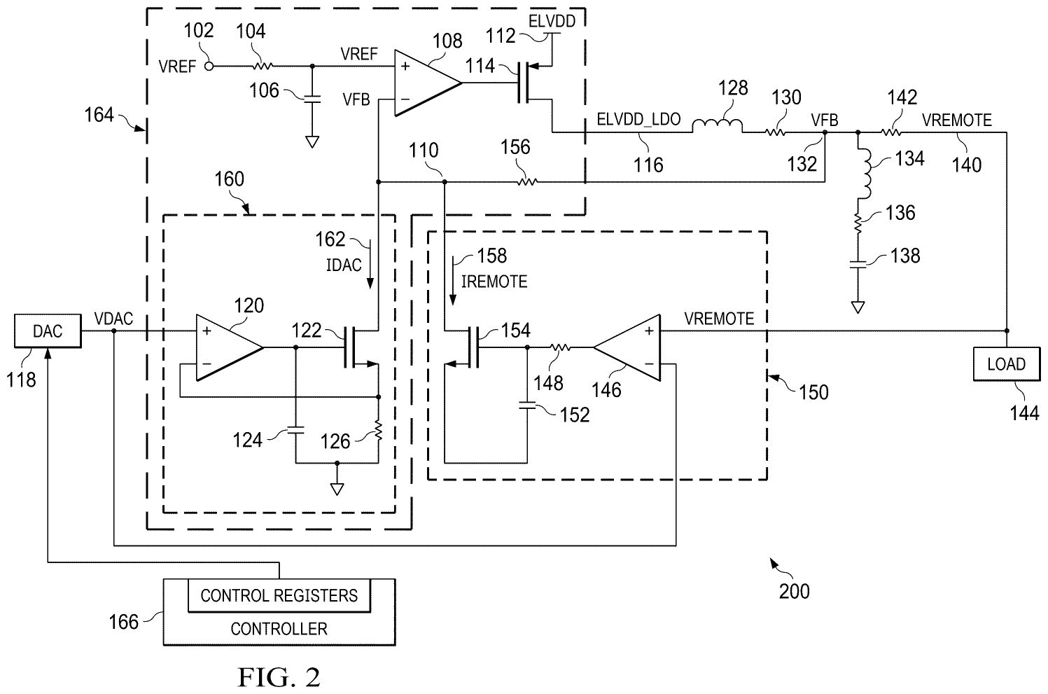

FIG. 2 shows a schematic diagram of LDO 200 with a higher bandwidth inner control loop 164 and a lower bandwidth outer control loop 150 that uses a single DAC to provide the voltages VREG and VDAC, according to an embodiment of the present disclosure. LDO 200 may be implemented in a similar manner as LDO 100, and the operation of LDO 200 may also be similar to the operation of LDO 100, except that LDO 200 has only one DAC which produces the reference voltage VDAC that is provided to the non-inverting input of amplifier 120 and to the non-inverting input of amplifier 146.

The voltage VDAC may be equal to the voltage VREG because there is no difference in voltage between the feedback voltage terminal VFB 132 and the voltage at the load VREMOTE 140 if there is no current flowing through the resistance of the cable R_{CABLE} 142. As the current through the resistance R_{CABLE} 142 increases, the voltage at the feedback voltage terminal VFB 132 increases to keep the same voltage at VREMOTE 140. As the inner control loop 164 regulates the voltage at the feedback voltage terminal VFB 132 to the desired target voltage for VREMOTE 140, the outer control loop 150 compensates by increasing the voltage at the feedback voltage terminal VFB 132 as the voltage at the load VREMOTE 140 decreases. In some cases, VREG may be at a different voltage than VDAC. In these cases, a voltage divider between the output of DAC 118 and the ground terminal may be used to generate a VREG voltage that is proportional to VDAC while still only using one DAC to provide both voltages.

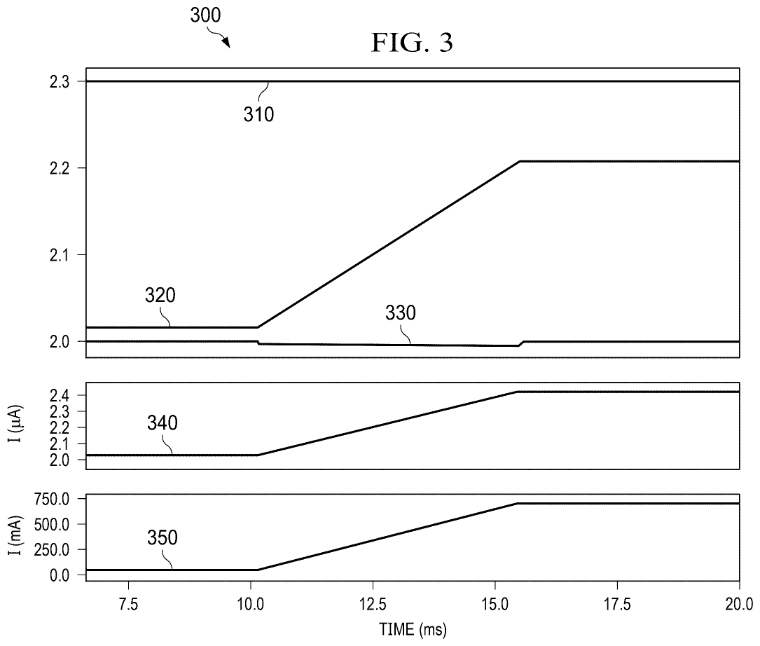

FIG. 3 shows a plot of voltages and currents versus time 300 associated with LDO 100 or 200 with a higher bandwidth inner control loop and a lower bandwidth outer control loop, according to an embodiment of the present disclosure. Curve 310 is a plot of voltage versus time for the supply voltage ELVDD 112. Curve 320 is a plot of voltage versus time for the LDO output voltage ELVDD_LDO 116. Curve 330 is a plot of voltage versus time for the voltage supplied to the load VREMOTE 140. Curve 340 is a plot of current versus time for the current flowing through resistor 156. Curve 350 is a plot of current versus time for the current being delivered to the load 144.

The supply voltage ELVDD in curve 310 remains constant throughout the time period. In curve 350, the load current is increased linearly from a first current level to a second current level where it then remains. In curve 340, in response to the increase in load current, the current through resistor 156 increases proportionally from a first current level to a second current level where it also remains. As the current through resistor 156 increases from a first level to a second level, the voltage at the LDO output ELVDD_LDO in curve 320 increases from a first voltage level to a second voltage level where it remains. The voltage supplied to the load in curve 330 remains relatively constant at its target voltage level with only momentary voltage disturbances occurring at the time the load begins to ramp and at the time it reaches its final value.

As the load current increases, if the outer control loop 150 had not been present in the LDO, the output voltage ELVDD_LDO in curve 320 would have remained constant and the voltage supplied to the load in curve 330 would have dropped as the load current increased. But because of the effect of the outer control loop 150 increasing the voltage at the output of the LDO, the voltage at the load in curve 330 remained regulated to the target voltage.

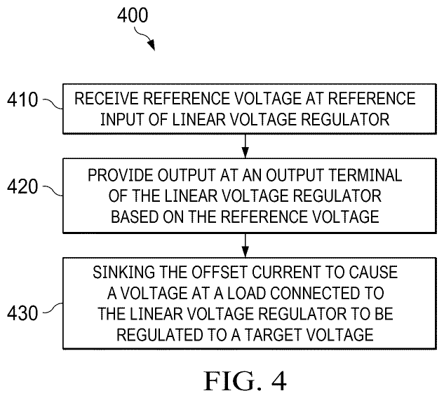

FIG. 4 shows a flow diagram of embodiment method 400 for point of load voltage regulation, according to an embodiment of the present disclosure. In step 410, a reference voltage (e.g., VREF) is received at a reference input (e.g., 102) of a linear voltage regulator. In step 420, an output voltage (e.g., ELVDD_LDO) is provided at an output terminal of the linear voltage regulator based on the reference voltage. This may be done by comparing a feedback voltage (e.g., VFB) to the reference voltage and making corrections to the output voltage in response to the difference between the two voltages.

In step 430, an auxiliary circuit (e.g., 150) sinks an offset current (e.g., IREMOTE) in response to a comparison between a target voltage (e.g., VDAC) and a remote voltage (e.g., VREMOTE) at a load (e.g., 144). In some embodiments, such auxiliary circuit has a lower bandwidth than the linear voltage regulator and forms an outer control loop around the linear voltage regulator control loop.

Example embodiments of the present disclosure are summarized here. Other embodiments can also be understood from the entirety of the specification and the claims filed herein.

Example 1. An electronic circuit including: a reference voltage terminal; a regulator output terminal; a feedback terminal; a first amplifier having first and second inputs and an output, the first input of the first amplifier coupled to the reference voltage terminal, the second input of the first amplifier coupled to the feedback terminal; a first transistor having first and second terminals and a control terminal, the control terminal of the first transistor coupled to the output of the first amplifier, the first terminal of the first transistor coupled to a supply voltage terminal, and the second terminal of the first transistor coupled to the regulator output terminal; a first resistor coupled between the second input of the first amplifier and the feedback terminal; and an auxiliary circuit having an input and an output, the output of the auxiliary circuit coupled to the second input of the first amplifier.

Example 2. The electronic circuit of example 1, where the auxiliary circuit includes: a second transistor having first and second terminals and a control terminal, the second terminal of the second transistor coupled to the second input of the first amplifier; and a second amplifier having an output coupled to the control terminal of the second transistor.

Example 3. The electronic circuit of one of examples 1 or 2, further including: a second resistor coupled between the output of the second amplifier and the control terminal of the second transistor; and a capacitor coupled to the second resistor.

Example 4. The electronic circuit of one of examples 1 to 3, further including a voltage-to-current (V2I) converter having an output coupled to the second input of the first amplifier.

Example 5. The electronic circuit of one of examples 1 to 4, where the V2I converter includes: a third transistor having first and second terminals and a control terminal, the first terminal of the third transistor coupled to the second input of the first amplifier; and a third amplifier having first and second inputs and an output, the output of the third amplifier coupled to the control terminal of the third transistor, the second input of the third amplifier coupled to the second terminal of the third transistor.

Example 6. The electronic circuit of one of examples 1 to 5, where the V2I converter further includes: a second resistor coupled to the second terminal of the third transistor; and a capacitor coupled to the output of the third amplifier.

Example 7. The electronic circuit of one of examples 1 to 6, further including a first digital to analog converter (DAC) having an output coupled to the first input of the third amplifier.

Example 8. The electronic circuit of one of examples 1 to 7, where the output of the first DAC is coupled to an input of the second amplifier.

Example 9. The electronic circuit of one of examples 1 to 8, further including a second DAC having an output coupled to an input of the second amplifier.

Example 10. The electronic circuit of one of examples 1 to 9, further including a load coupled to an input of the second amplifier and to the regulator output terminal.

Example 11. The electronic circuit of one of examples 1 to 10, further including a linear voltage regulator including the first amplifier and the first transistor, the linear voltage regulator configured to regulate a voltage at an input of the auxiliary circuit based on a reference voltage at the reference voltage terminal and the output of the auxiliary circuit.

Example 12. The electronic circuit of one of examples 1 to 11, where the auxiliary circuit is configured to sink a current from the first resistor based on a voltage at the feedback terminal.

Example 13. The electronic circuit of one of examples 1 to 12, further including a digital to analog converter (DAC), where the auxiliary circuit is configured to sink the current from the first resistor based on an output of the DAC.

Example 14. The electronic circuit of one of examples 1 to 13, where a magnitude of the current is proportional to a difference between a voltage at a load and a voltage at the feedback terminal.

Example 15. The electronic circuit of one of examples 1 to 14, further including a lowpass filter coupled between the reference voltage terminal and the first input of the first amplifier.

Example 16. The electronic circuit of one of examples 1 to 15, where the lowpass filter includes a second resistor and a capacitor.

Example 17. The electronic circuit of one of examples 1 to 16, further including a capacitor coupled between the feedback terminal and a ground terminal.

Example 18. The electronic circuit of one of examples 1 to 17, further including a voltage regulator configured to regulate a voltage at an input of the auxiliary circuit, the voltage regulator including an inner regulation loop, and an outer regulation loop, the inner regulation loop including the first amplifier, the first transistor, and the first resistor, the outer regulation loop including the first amplifier, the first transistor, and the auxiliary circuit, the inner regulation loop having a higher bandwidth than the outer regulation loop.

Example 19. The electronic circuit of one of examples 1 to 18, where the auxiliary circuit is configured to sink an offset current at the output of the auxiliary circuit to cause an input of the auxiliary circuit to be regulated to a target voltage.

Example 20. A method including: receiving a reference voltage at a reference input of a linear voltage regulator; providing an output, by the linear voltage regulator, at an output terminal of the linear voltage regulator, based on the reference voltage; and sinking an offset current from a resistor that is coupled between the output of the linear voltage regulator and a feedback input of the linear voltage regulator to cause a voltage at a load that is coupled to the output of the linear voltage regulator to be regulated to a target voltage.

Example 21. The method of example 20, where a bandwidth of the linear voltage regulator is higher than a bandwidth of an auxiliary circuit sinking the offset current.

In this description, even if operations are described in a particular order, some operations may be optional, and the operations are not necessarily required to be performed in that particular order to achieve specified results. In some examples, multitasking and parallel processing may be advantageous. Moreover, a separation of various system components in some embodiments does not necessarily require such separation in all embodiments.

Modifications are possible in the described embodiments, and other embodiments are possible, within the scope of the claims.

What is claimed is:

1. An electronic circuit comprising:
a reference voltage terminal;
a regulator output terminal;
a feedback terminal;
a first amplifier having first and second inputs and an output, the first input of the first amplifier coupled to the reference voltage terminal, the second input of the first amplifier coupled to the feedback terminal;
a first transistor having first and second terminals and a control terminal, the control terminal of the first transistor coupled to the output of the first amplifier, the first terminal of the first transistor coupled to a supply voltage terminal, and the second terminal of the first transistor coupled to the regulator output terminal;
a first resistor coupled between the second input of the first amplifier and the feedback terminal; and
an auxiliary circuit having an input and an output, the output of the auxiliary circuit coupled to the second input of the first amplifier.

2. The electronic circuit of claim 1, wherein the auxiliary circuit includes:
a second transistor having first and second terminals and a control terminal, the second terminal of the second transistor coupled to the second input of the first amplifier; and
a second amplifier having an output coupled to the control terminal of the second transistor.

3. The electronic circuit of claim 2, further comprising:
a second resistor coupled between the output of the second amplifier and the control terminal of the second transistor; and
a capacitor coupled to the second resistor.

4. The electronic circuit of claim 2, further comprising a voltage-to-current (V2I) converter having an output coupled to the second input of the first amplifier.

5. The electronic circuit of claim 4, wherein the V2I converter includes:
a third transistor having first and second terminals and a control terminal, the first terminal of the third transistor coupled to the second input of the first amplifier; and
a third amplifier having first and second inputs and an output, the output of the third amplifier coupled to the control terminal of the third transistor, the second input of the third amplifier coupled to the second terminal of the third transistor.

6. The electronic circuit of claim 5, wherein the V2I converter further comprises:
a second resistor coupled to the second terminal of the third transistor; and
a capacitor coupled to the output of the third amplifier.

7. The electronic circuit of claim 5, further comprising a first digital to analog converter (DAC) having an output coupled to the first input of the third amplifier.

8. The electronic circuit of claim 7, wherein the output of the first DAC is coupled to an input of the second amplifier.

9. The electronic circuit of claim 7, further comprising a second DAC having an output coupled to an input of the second amplifier.

10. The electronic circuit of claim 2, further comprising a load coupled to an input of the second amplifier and to the regulator output terminal.

11. The electronic circuit of claim 1, further comprising a linear voltage regulator comprising the first amplifier and the first transistor, the linear voltage regulator configured to regulate a voltage at an input of the auxiliary circuit based on a reference voltage at the reference voltage terminal and the output of the auxiliary circuit.

12. The electronic circuit of claim 1, wherein the auxiliary circuit is configured to sink a current from the first resistor based on a voltage at the feedback terminal.

13. The electronic circuit of claim 12, further comprising a digital to analog converter (DAC), wherein the auxiliary circuit is configured to sink the current from the first resistor based on an output of the DAC.

14. The electronic circuit of claim 12, wherein a magnitude of the current is proportional to a difference between a voltage at a load and a voltage at the feedback terminal.

15. The electronic circuit of claim 1, further comprising a lowpass filter coupled between the reference voltage terminal and the first input of the first amplifier.

16. The electronic circuit of claim 15, wherein the lowpass filter includes a second resistor and a capacitor.

17. The electronic circuit of claim 1, further comprising a capacitor coupled between the feedback terminal and a ground terminal.

18. The electronic circuit of claim 1, further comprising a voltage regulator configured to regulate a voltage at an input of the auxiliary circuit, the voltage regulator comprising an inner regulation loop, and an outer regulation loop, the inner regulation loop comprising the first amplifier, the first transistor, and the first resistor, the outer regulation loop comprising the first amplifier, the first transistor, and the auxiliary circuit, the inner regulation loop having a higher bandwidth than the outer regulation loop.

19. The electronic circuit of claim 1, wherein the auxiliary circuit is configured to sink an offset current at the output of the auxiliary circuit to cause an input of the auxiliary circuit to be regulated to a target voltage.

20. A method comprising:
receiving a reference voltage at a reference input of a linear voltage regulator;
providing an output, by the linear voltage regulator, at an output terminal of the linear voltage regulator, based on the reference voltage; and
sinking an offset current from a resistor that is coupled between the output of the linear voltage regulator and a feedback input of the linear voltage regulator to cause a voltage at a load that is coupled to the output of the linear voltage regulator to be regulated to a target voltage.

21. The method of claim 20, wherein a bandwidth of the linear voltage regulator is higher than a bandwidth of an auxiliary circuit sinking the offset current.
